(19) United States
(12) Patent Application Publication
(10) Pub. No.: US 2026/0179182 A1
(43) Pub. Date: Jun. 25, 2026

(54) METHOD AND APPARATUS FOR TRAINING A VIDEO FRAME INTERPOLATION MODEL, AND A METHOD FOR VIDEO FRAME INTERPOLATION USING SAID MODEL

(71) Applicant: KOREA ADVANCED INSTITUTE OF SCIENCE AND TECHNOLOGY, Daejeon (KR)

(72) Inventors: MunChurl KIM, Daejeon (KR); Wonyong SEO, Daejeon (KR)

(73) Assignee: KOREA ADVANCED INSTITUTE OF SCIENCE AND TECHNOLOGY, Daejeon (KR)

(21) Appl. No.: 19/460,786

(22) Filed: Jan. 27, 2026

Related U.S. Application Data
(63) Continuation of application No. PCT/KR2025/020768, filed on Dec. 4, 2025.

(30) Foreign Application Priority Data
Dec. 13, 2024 (KR) 10-2024-0186498
Dec. 4, 2025 (KR) 10-2025-0190310

(51) Int. Cl. G06T 3/4046; G06N 3/08; G06T 3/4007; G06T 7/254

(52) U.S. Cl. CPC G06T 3/4046; G06N 3/08; G06T 3/4007; G06T 7/254; G06T 2207/20081; G06T 2207/20084; G06T 2207/20224

(57) ABSTRACT

A method and apparatus for training a video frame interpolation (VFI) model and a VFI method using the model are provided. The method of training the VFI model includes, based on a first image sequence including a first image frame, a second image frame, and an intermediate image frame, generating image feature maps corresponding to respective image frames, generating a motion information field including per-pixel angular difference information, generating a first backward motion vector field and a first forward motion vector field by inputting, to a first neural network, the motion information field and image feature maps, generating a first output image frame by inputting, to a second neural network, the first backward motion vector field and the first forward motion vector field, and based on a difference between the intermediate image frame and the first output image frame, training the first neural network and the second neural network.

### CROSS-REFERENCE TO RELATED APPLICATIONS

This application is bypass continuation of PCT International Application No. PCT/KR2025/020768, filed Dec. 4, 2025, which claims the benefit of priority under 35 U.S.C. § 119 to KR 10-2024-0186498, filed Dec. 13, 2024 and KR 10-2025-0190310, filed Dec. 4, 2025 the contents of which are incorporated herein by reference in their entirety.

### TECHNICAL FIELD

A method and apparatus for training a video frame interpolation (VFI) model and a VFI method using the model

### BACKGROUND

Video frame interpolation (VFI) is widely used to increase the frame rate of a video. VFI is a technique for generating a new image frame between two consecutive frames of an original video. Through VFI, a video with a low frame rate may be converted into a video with a high frame rate. A video with a high frame rate may appear visually smoother and more natural than a video with a low frame rate.

The present disclosure is developed with the support of the Ministry of Science and ICT (Project No.: RS-2022-00144444, Program: ICT/Broadcasting Technology Development Program, Research Project: Study on Deep Learning-Based Spatial Image Representation Training and Rendering for Static and Dynamic Scenes, Host Institution: Korea Advanced Institute of Science and Technology, Research Management Agency: Institute for Information & Communications Technology Planning & Evaluation).

### SUMMARY

According to an embodiment, a method of training a video frame interpolation (VFI) model includes, based on a first image sequence including a first image frame corresponding to a first time point, a second image frame corresponding to a second time point subsequent to the first time point, and an intermediate image frame corresponding to an intermediate time point between the first time point and the second time point, generating image feature maps corresponding to respective image frames, generating a motion information field including per-pixel angular difference information between per-pixel motion vectors between the first image frame and the intermediate image frame and per-pixel motion vectors between the second image frame and the intermediate image frame, generating a first backward motion vector field and a first forward motion vector field by inputting, to a first neural network for estimating a bidirectional motion vector field, the motion information field and image feature maps corresponding to the first image frame and the second image frame, generating a first output image frame by inputting, to a second neural network for estimating an image frame of the intermediate time point, the first backward motion vector field and the first forward motion vector field; and based on a difference between the intermediate image frame and the first output image frame, training the first neural network and the second neural network.

According to an embodiment, a training apparatus includes one or more processors and memory including instructions executable by the one or more processors, wherein the instructions, when executed by the one or more processors, may cause the training apparatus to, based on a first image sequence including a first image frame corresponding to a first time point, a second image frame corresponding to a second time point subsequent to the first time point, and an intermediate image frame corresponding to an intermediate time point between the first time point and the second time point, generate image feature maps corresponding to respective image frames, generate a motion information field including per-pixel angular difference information between per-pixel motion vectors between the first image frame and the intermediate image frame and per-pixel motion vectors between the second image frame and the intermediate image frame, generate a first backward motion vector field and a first forward motion vector field by inputting, to a first neural network for estimating a bidirectional motion vector field, the motion information field and image feature maps corresponding to the first image frame and the second image frame, generate a first output image frame by inputting, to a second neural network for estimating an image frame at the intermediate time point, the first backward motion vector field and the first forward motion vector field, and based on a difference between the intermediate image frame and the first output image frame, train the first neural network and the second neural network.

According to an embodiment a VFI method includes initializing a pre-trained VFI model, receiving an input image sequence including a first input image frame at a first input time point and a second input image frame at a second input time point, determining a target motion information field including per-pixel angular difference information between per-pixel motion vectors between the first input image frame and a target image frame corresponding to a target time point between the first input time point and the second input time point and per-pixel motion vectors between the second input image frame and the target image frame, and generating the target image frame corresponding to the target time point by inputting, to the trained VFI model, the input image sequence and the target motion information field.

### BRIEF DESCRIPTION OF DRAWINGS

FIG. 1 is a block diagram illustrating an operation of generating a target image frame of an electronic apparatus, according to an embodiment.

FIG. 2 is a diagram illustrating an operation of generating a target image frame of a video frame interpolation (VFI) model, according to an embodiment.

FIG. 3 is a diagram illustrating performance differences of a VFI model according to training indices, according to an embodiment.

FIG. 4 is a block diagram schematically illustrating a process of generating a target image frame using a VFI model, according to an embodiment.

FIG. 5 is a diagram illustrating an example of a process of inferring a first neural network, according to an embodiment.

FIG. 6 is a block diagram schematically illustrating a process of training a VFI model, according to an embodiment.

FIG. 7 is a flowchart illustrating an example of a method by which a training apparatus trains a VFI model, according to an embodiment.

FIG. 8 is a block diagram illustrating a configuration of a VFI apparatus according to an embodiment.

FIG. 9 is a block diagram illustrating a configuration of a training apparatus according to an embodiment.

FIG. 10 is a block diagram illustrating an example of a configuration of an electronic apparatus for training a VFI model, according to an embodiment.

### DETAILED DESCRIPTION OF THE EMBODIMENTS

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like, may be used herein to describe various components, these terms should be used only to distinguish one component from another component. For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like elements and a repeated description related thereto will be omitted.

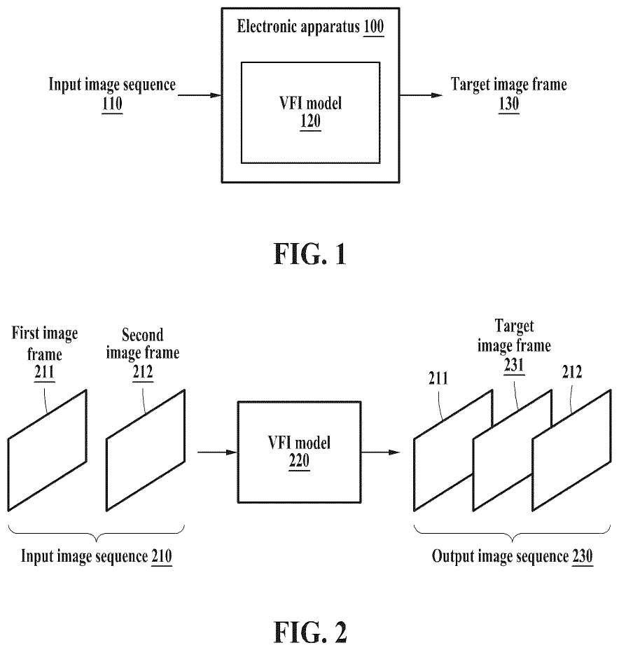

FIG. 1 is a block diagram illustrating an operation of generating a target image frame of an electronic apparatus, according to an embodiment. Referring to FIG. 1, an electronic apparatus 100 may receive an input image sequence 110. The input image sequence 110 may include a plurality of image frames. The input image sequence 110 may correspond to a video with a low frame rate.

The electronic apparatus 100 may be referred to as a video frame interpolation (VFI) apparatus. The electronic apparatus 100 may include a VFI model 120. The VFI model 120 may correspond to a software module. Using the VFI model 120, the electronic apparatus 100 may perform VFI on the input image sequence 110.

The electronic apparatus 100 may input the input image sequence 110 to the VFI model 120. The VFI model 120 may generate a new image frame between two consecutive image frames of an input video so that the frame rate of the video is improved. For example, the VFI model 120 may generate a new target image frame 130 between the two consecutive image frames of the input image sequence 110.

The VFI model 120 may generate a video with an improved frame rate based on the input video and the generated image frames. For example, the VFI model 120 may generate and/or output an output image sequence including the input image sequence 110 and the target image frame 130. The output image sequence may correspond to a video with a high frame rate.

The VFI model 120 may correspond to a model trained to generate a video with a higher frame rate in response to the input video. The VFI model 120 may include one or more neural networks. In an embodiment, the electronic apparatus 100 may include a training apparatus for training the VFI model 120. The training apparatus may train the VFI model 120. For example, the training apparatus may train the one or more neural networks of the VFI model 120. The one or more neural networks of the VFI model 120 may be trained based on deep learning and then perform inference suitable for a given purpose by mapping input data to output data that are in a nonlinear relationship.

The training apparatus may train the VFI model 120 based on a training image sequence including three image frames. The training apparatus may be trained to estimate, from two image frames of the training image sequence, an image frame between the two image frames. The training apparatus may utilize an index of the training image sequence to train the VFI model 120. The index may include, for example, information about a time (time point) corresponding to each image frame, information about the magnitude (distance) of a motion vector between image frames, and/or information about the direction (angle) of a motion vector between image frames.

When the index of the training image sequence is not properly utilized in training the VFI model 120, a motion between the image frames of the training image sequence may not be accurately expressed. In this case, motion ambiguity may occur during an image frame generation process of the VFI model 120 due to an inaccurately expressed motion in the training image sequence. Motion ambiguity may be referred to as time-to-location ambiguity. The one or more neural networks of the VFI model 120 may not be trained to determine a single appropriate motion from among numerous motions that may exist between the two consecutive image frames of the input image sequence 110. In this case, the target image frame 130 generated by the VFI model 120 may appear blurry.

The training apparatus of the electronic apparatus 100 may train the VFI model 120 by utilizing the index including the information about the magnitude (distance) of a motion vector between image frames and/or the information about the direction (angle) of a motion vector between image frames. An index may represent non-uniform motion (e.g., non-linear and non-constant motion) between the image frames of the training image sequence. The VFI model 120, which is trained on an image sequence in which non-uniform motion is expressed, may generate the target image frame 130 that is clear rather than blurry.

FIG. 2 is a diagram illustrating an operation of generating a target image frame of a VFI model, according to an embodiment. Referring to FIG. 2, an input image sequence 210 may be input to a VFI model 220. The input image sequence 210 and the VFI model 220 may respectively correspond to the input image sequence 110 and the VFI model 120 of FIG. 1. The input image sequence 210 may include a first image frame 211 and a second image frame 212. The first image frame 211 and the second image frame 212 may correspond to two consecutive image frames of the input image sequence 210. The first image frame 211 may be an image frame corresponding to a first time point. The second image frame 212 may be an image frame corresponding to a second time point.

The VFI model 220 may generate and/or output a target image frame 231 based on the input image sequence 210. The target image frame 231 may correspond to the target image frame 130 of FIG. 1. The VFI model 220 may generate and/or output an output image sequence 230 based on the input image sequence 210 and the target image frame 231. The output image sequence 230 may include the first image frame 211, the second image frame 212, and the target image frame 231.

The target image frame 231 may correspond to an intermediate time point (e.g., t=0.5) between the first time point (e.g., t=0) corresponding to the first image frame 211 and the second time point (e.g., t=1) corresponding to the second image frame 212 within the output image sequence 230. Although FIG. 2 illustrates that the VFI model 220 generates “one” image frame (the target image frame 231) corresponding to “one” time point between two consecutive image frames (the first image frame 211 and the second image frame 212), it may also be possible for the VFI model 220 to generate “a plurality of” image frames corresponding to “a plurality of” time points (e.g., t=0.25, t=0.5, and t=0.75) between two consecutive image frames (the first image frame 211 and the second image frame 212).

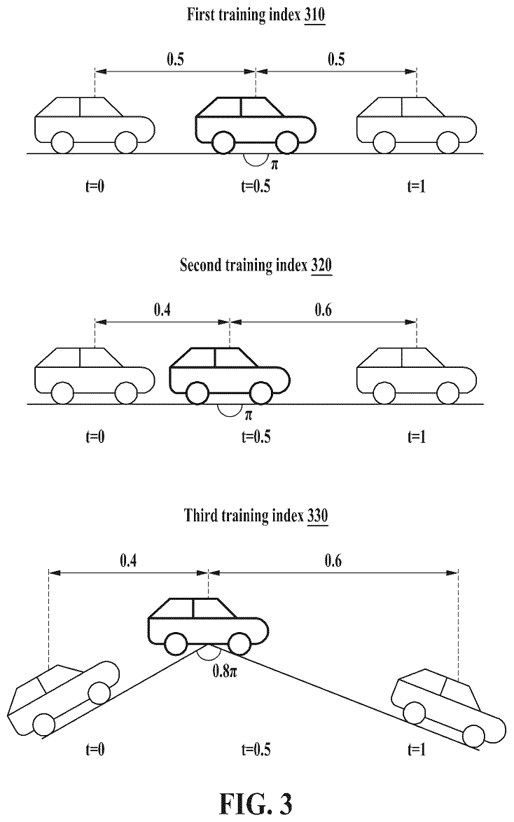

FIG. 3 is a diagram illustrating performance differences of a VFI model according to training indices, according to an embodiment. A training apparatus may train a VFI model by utilizing training indices of image frames of a training image sequence. The training index examples illustrated in FIG. 3 are described through three image frames of a training image sequence. The three image frames of the training image sequence may include a first image frame (t=0), a second image frame (t=1), and an intermediate image frame (t=0.5).

Referring to FIG. 3, a first training index 310 may include information about a time point and may not include information about the magnitude (distance) of a motion vector between image frames and information about the direction (angle) of a motion vector between image frames. A second training index 320 may include information about a time point and information about the magnitude (distance) of a motion vector between image frames and may not include information about the direction (angle) of a motion vector between image frames. According to the second training index 320, the magnitude of a motion between the first image frame and the intermediate image frame may be expressed differently from the magnitude of a motion between the intermediate image frame and the second image frame. However, a motion in a different direction may not be expressed between the first image frame and the second image frame. A third training index 330 may include information about a time point, information about the magnitude (distance) of a motion vector between image frames, and information about the direction (angle) of a motion vector between image frames. According to the third training index 330, the magnitude and direction of a motion between the first image frame and the intermediate image frame may be expressed differently from the magnitude and direction of a motion between the intermediate image frame and the second image frame.

Information about the magnitude (distance) of a motion vector between image frames may include information about the magnitude of a per-pixel motion vector. In an embodiment, information about the magnitude of a per-pixel motion vector between image frames may include information about the “difference” in the magnitude of a per-pixel motion vector between image frames. For example, information about the magnitude of a per-pixel motion vector between image frames may include information about the difference in the magnitude of a motion vector between the first image frame and the intermediate image frame and the magnitude of a motion vector between the intermediate image frame and the second image frame. In an embodiment, information about the difference in the magnitudes of motion vectors may be expressed as a ratio between the magnitudes of two motion vectors.

Compared to a case in which the first training index 310 or the second training index 320 is used, when a VFI model is trained using a distance index and an angle index, such as the third training index 330, as shown in FIG. 3, changes in motions within image frames used for training may be accurately expressed, and the position of an object within the intermediate image frame may be accurately expressed. The VFI model is trained using the third training index 330, the issue of time-to-location ambiguity may be significantly reduced, and the VFI model may generate a clearer image.

Information about the magnitude (distance) of a motion vector of the third training index 330 and information about the direction (angle) of a motion vector between image frames may be expressed based on per-pixel motion vectors between the image frames. A motion vector may represent a change in the position of a pixel between image frames. Per-pixel motion vectors between image frames may be referred to as a motion vector field. For example, a motion vector field between the first image frame (t=0) and the intermediate image frame (t=0.5) may be referred to as a backward motion vector field, and a motion vector field between the intermediate image frame (t=0.5) and the second image frame (t=1) may be referred to as a forward motion vector field. A backward motion vector field may include per-pixel motion vectors from an intermediate image frame to a previous image frame. A forward motion vector field may include per-pixel motion vectors from an intermediate image frame to a subsequent image frame.

A motion vector field between image frames of a training image sequence may be determined and/or estimated in various ways. For example, a motion vector field may be determined and/or estimated based on the brightness of pixels between image frames. A motion vector field corresponding to the brightness of a pixel may be referred to as optical flow. Additionally, for example, a motion vector field may be determined and/or estimated by a neural network.

$${M}_{t \to 0 , 1} ( x , y ) = {[ R ( x , y ) , Φ ( x , y ) ]}^{T} = {[ \frac{{r}_{0}}{{r}_{0} + {r}_{1}} , ϕ ]}^{T} \qquad [ Equation 1 ]$$

Information about the magnitude (distance) of a motion vector of the third training index 330 and information about the direction (angle) of a motion vector between image frames may be expressed as a vector field, for example, as shown in Equation 1 above. t may represent a time point corresponding to an intermediate image frame between an image frame of time point 0 and an image frame of time point 1.

M_{t→0,1}(x,y) may be referred to as a motion information field. R(x,y) may represent the ratios of the magnitude (distance) of a per-pixel motion vector. r₀ and r₁ may represent the magnitude of per-pixel backward motion vectors and the magnitude of per-pixel forward motion vectors, respectively. R(x,y) may represent per-pixel normalized ratios between r₀ and r₁. Φ(x,y) and φ may represent “the per-pixel angular difference between the angle of per-pixel backward motion vectors and the angle of per-pixel forward motion vectors” for each backward pixel. The angle of a per-pixel motion vector may be determined, for example, as shown in Equation 2 below. For example, when a motion vector corresponding to one pixel is (2, 4), the angle may be tan⁻¹ 2.

$${tan}^{- 1} \{ \frac{( y value of per - pixel motion vector )}{( x value of per - pixel motion vector )} \} \qquad [ Equation 2 ]$$

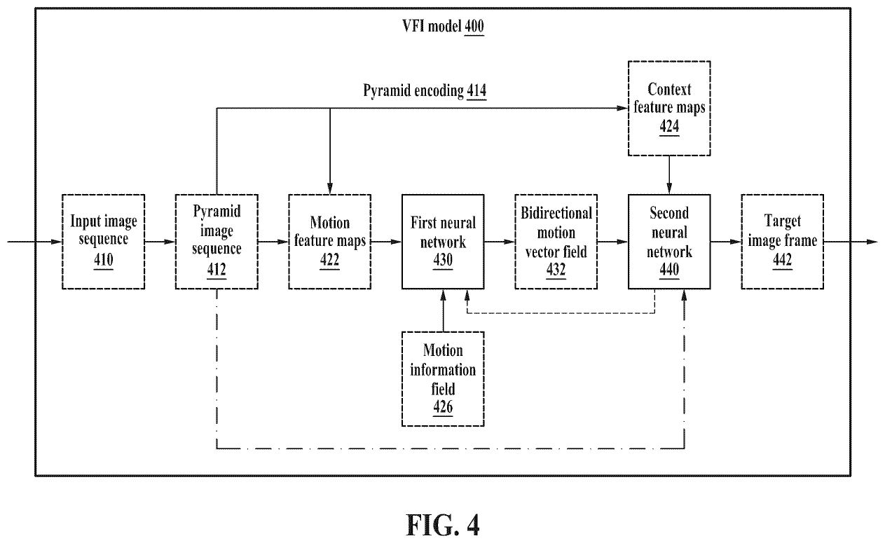

FIG. 4 is a block diagram schematically illustrating a process of generating a target image frame using a VFI model, according to an embodiment. Referring to FIG. 4, an electronic apparatus may input an input image sequence 410 to a VFI model 400. The electronic apparatus may generate a target image frame 442 of a target time point based on the input image sequence 410 through the VFI model 400. A target time point may correspond to a time point between a first time point and a second time point. The first and second time points may respectively correspond to a first image frame and a second image frame, which are consecutive image frames of an input image sequence. The target image frame 442 may correspond to the target image frame 130 of FIG. 1.

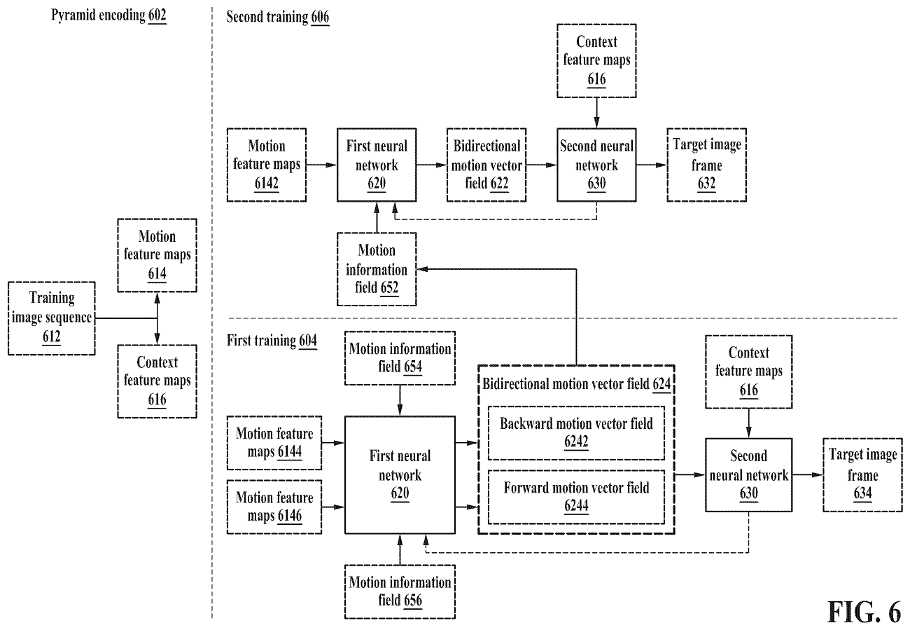

The VFI model 400 may be a pre-trained model to perform VFI based on an input image sequence (e.g., the input image sequence 410) to generate a new image frame (e.g., the target image frame 442). A method of training the VFI model 400 is described in detail below with reference to FIG. 6. The electronic apparatus may initialize the VFI model 400 before inputting the input image sequence 410 to the VFI model 400. Initialization of the VFI model 400 may include loading the VFI model 400, which is pre-trained, into memory. For example, in accordance with the initialization of the VFI model 400, all parameters of a first neural network 430 and a second neural network 440 that are pre-trained may be loaded. When the VFI model 400 is initialized, a value, which is input to the VFI model 400 when the VFI model 400 before initialization is used, may not affect the initialized VFI model 400.

The electronic apparatus may generate a pyramid image sequence 412 based on the input image sequence 410. The electronic apparatus may generate the pyramid image sequence 412 based on a plurality of encoding levels. The plurality of encoding levels may include a predetermined L levels. The electronic apparatus may generate an image sequence of each encoding level by performing downsampling on the input image sequence 410. k may represent an encoding level. The sizes of image frames of image sequences at respective encoding levels of the pyramid image sequence 412 may be different from one another. As the encoding level increases, the size of an image frame in an image sequence may become smaller. For example, an image sequence at encoding level k may have a scale that is 2^{k} times smaller than the input image sequence 410. The pyramid image sequence 412 may include the input image sequence 410. The input image sequence 410 may be an image sequence corresponding to encoding level 0.

The electronic apparatus may generate image feature maps by performing pyramid encoding 414 on the pyramid image sequence 412. The image feature maps may include motion feature maps 422 and context feature maps 424. The VFI model 400 may include a motion feature extractor for generating the motion feature maps 422 and a context feature extractor for generating the context feature maps 424. The motion feature maps 422 may be feature maps used to estimate a bidirectional motion field. The context feature maps 424 may be feature maps used to estimate an image frame at a target time point between the time points of two image frames.

The pyramid encoding 414 may include a plurality of encoding levels. The plurality of encoding levels of the pyramid encoding 414 may correspond to the plurality of encoding levels of the pyramid image sequence 412. The electronic apparatus may generate image feature maps corresponding to respective encoding levels through the pyramid encoding 414. For example, the motion feature maps 422 may include motion feature maps corresponding to the input image sequence 410 at encoding level 0 and motion feature maps corresponding to an image sequence at encoding level (L−1).

The motion feature maps 422 may include motion feature maps corresponding to respective encoding levels. The motion feature maps corresponding to respective encoding levels may each have a motion feature map corresponding to each image frame of an image sequence corresponding to each encoding level. The context feature maps 424 may include context feature maps corresponding to respective encoding levels. The context feature maps corresponding to respective encoding levels may each include a context feature map corresponding to an image frame of an image sequence corresponding to each encoding level.

The VFI model 400 may include the first neural network 430 and the second neural network 440. The electronic apparatus may perform pyramid decoding using the first neural network 430 and the second neural network 440. The electronic apparatus may perform pyramid decoding based on the motion feature maps 422, the context feature maps 424, and a motion information field 426. The electronic apparatus may generate the target image frame 442 by performing pyramid decoding. The motion information field 426 may correspond to the motion information field described with reference to FIG. 3 and/or Equation 1.

Pyramid decoding may include a plurality of decoding levels. The plurality of decoding levels may correspond to a plurality of encoding levels. For example, decoding level k of pyramid decoding may use information from encoding level k. Pyramid decoding may start from decoding level (L−1). At decoding level k, the electronic apparatus may input the motion feature maps 422 and the motion information field 426 to the first neural network 430. At decoding level k, the motion feature maps 422 may represent motion feature maps corresponding to first and second time points generated corresponding to encoding level k. The first neural network 430 may be a neural network trained to estimate a bidirectional motion vector field from a target time point to the time points (e.g., the first time point and the second time point) of two image frames of the input image sequence 410. At decoding level k, using the first neural network 430, the electronic apparatus may generate a bidirectional motion vector field 432 corresponding to decoding level k.

At decoding level k, the motion information field 426 may have a size corresponding to the image sequence at encoding level k. The electronic apparatus may determine the motion information field 426 to include per-pixel angular difference information and/or per-pixel motion vector magnitude difference information between per-pixel forward motion vectors between the first image frame and the target frame of the input image sequence 410 and per-pixel backward motion vectors between a second input image frame of the input image sequence 410 and a target image frame.

In an embodiment, the electronic apparatus may estimate information regarding the motion information field 426 and then determine the motion information field 426 based on the estimated information. For example, the electronic apparatus may estimate per-pixel angular difference information and/or per-pixel motion vector magnitude difference information between per-pixel forward motion vectors and per-pixel backward motion vectors. The electronic apparatus may determine the motion information field 426 to include the estimated information. The estimation of motion vector information related to a target image frame may be estimated, for example, through a separately trained neural network (not shown).

In an embodiment, instead of estimating the exact motion of a target time point between the time points of consecutive image frames of the input image sequence 410, the electronic apparatus may determine the motion information field 426 by assuming that the motion between the time points of the consecutive image frames of the input image sequence 410 is uniform. In this case, the electronic apparatus may determine the motion information field 426 as shown in Equation 3 below. t may correspond to a target time point, and H and W may correspond to the height and width of an image frame of an image sequence at encoding level k, respectively. According to Equation 3, the electronic apparatus may determine the per-pixel angular difference between a forward motion vector and a backward motion vector as 180° (π).

$${M}_{t \to 0 , 1}^{uni} = [ \begin{matrix}t \cdot {1}_{H \times W} & {π \cdot {1}_{H \times W} ]}^{T}\end{matrix} \qquad [ Equation 3 ]$$

At decoding level k, the electronic apparatus may input, to the second neural network 440, the bidirectional motion vector field 432, the context feature maps 424, and the image sequence of the pyramid image sequence 412. At decoding level k, the electronic apparatus may input, to the second neural network 440, the image sequence of the pyramid image sequence 412 corresponding to encoding level k. At decoding level k, the context feature maps 424 may represent context feature maps corresponding to the first and second time points generated corresponding to encoding level k. The second neural network 440 may be a neural network trained to estimate an image frame at a target time point. An image frame output by the second neural network 440 at decoding level k may have the same size as an image frame of the image sequence at encoding level k. That is, the image frame at the target time point estimated at decoding level k may have a scale that is 2^{k} times smaller than the target image frame 442. The second neural network may be trained to further estimate an occlusion mask.

In an embodiment, the second neural network 440 may include an upsampling neural network and an image frame synthesis network. At decoding level k, the electronic apparatus may generate a bidirectional motion vector field of a greater size than the bidirectional motion vector field 432 by inputting, to the upsampling neural network, the bidirectional motion vector field 432 and the context feature maps 424. The upsampling neural network may correspond to an adaptive upsampling model. At decoding level k, the electronic apparatus may estimate and/or generate an image frame and/or an occlusion mask at a target time point by inputting, to the image frame synthesis network, the bidirectional motion vector field generated through the upsampling neural network, the context feature maps 424, and the image sequence corresponding to encoding level k. The image frame synthesis network may correspond to a U-net architecture.

The electronic apparatus may use data generated at decoding level k in pyramid decoding at decoding level (k−1). At decoding level (k−1), the electronic apparatus may input, to the first neural network 430, the bidirectional motion vector field upsampled at decoding level k and the occlusion mask.

The pyramid decoding may be terminated at decoding level 0. At decoding level 0, the electronic apparatus may estimate and/or generate the target image frame 442 having the same size as the image frame of the input image sequence 410 through the second neural network 440.

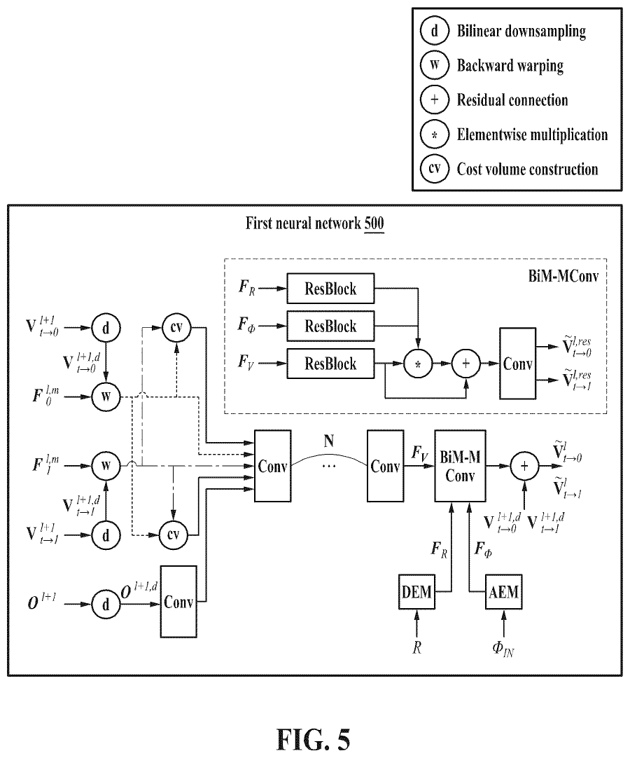

FIG. 5 is a diagram illustrating an example of an inference process of a first neural network, according to an embodiment. Referring to FIG. 5, a process of inferring a first neural network 500 at decoding level l is schematically illustrated.

At decoding level l, an electronic apparatus may input, to the first neural network 500, bidirectional motion vector fields

$$( {V}_{t \to 0}^{l + 1} and l + 1 )$$

generated at decoding level

$${V}_{t \to 1}^{l + 1} .$$

The bidirectional motion vector fields may correspond to directional motion vector fields output by an upsampling network corresponding to decoding level l+1 of FIG. 4.

$${V}_{t \to 0}^{l + 1} and {V}_{t \to 1}^{l + 1}$$

may represent a backward motion vector field and a forward motion vector field, respectively. t may represent a target time point, and 0 and 1 may be time points corresponding to consecutive image frames of an input image sequence.

At decoding level l, the electronic apparatus may input, to the first neural network 500, motion feature maps

$$( {F}_{0}^{l , m} and l )$$

at encoding level

$${F}_{1}^{l , m} .$$

The motion feature maps may correspond to the motion feature maps 422 of FIG. 4.

$${F}_{0}^{l , m} and {F}_{1}^{l , m}$$

may be motion feature maps at time points 0 and 1, respectively, among motion feature maps at encoding level l. At decoding level l, the electronic apparatus may input, to the first neural network 500, an occlusion mask (O^{l+1}) corresponding to decoding level l+1.

The first neural network 500 may generate

$${V}_{t \to 0}^{l + 1 , d} and {V}_{t \to 1}^{l + 1 , d}$$

by downsampling

$${V}_{t \to 0}^{l + 1} and {V}_{t \to 1}^{l + 1} .$$

For example,

$${V}_{t \to 0}^{l + 1} and {V}_{t \to 1}^{l + 1}$$

may have a scale that is 2^{(l+1)} times smaller than the image frames of the input image sequence, and

$${V}_{t \to 0}^{l + 1 , d} and {V}_{t \to 1}^{l + 1 , d}$$

may have a scale that is 2^{(l+2)} times smaller than the image frames of the input image sequence. The first neural network 500 may generate a warped motion feature map

$$( {F}_{0 \to t}^{l , m} )$$

by warping

$${F}_{0}^{l , m} using {V}_{t \to 0}^{l + 1 , d}$$

and may generate a warped motion feature map

$$( {F}_{1 \to t}^{l , m} )$$

by warping

$${F}_{1}^{l , m} using {V}_{t \to 1}^{l + 1 , d} .$$

The first neural network 500 may generate a cost volume to find a correspondence relationship (e.g., similarity) between

$${F}_{0 \to t}^{l , m} using {V}_{1 \to t}^{l , m} .$$

The first neural network 500 may generate O^{l+1,d} by downsampling O^{l+1}, convolve O^{l+1,d}, and then perform convolution by combining O^{l+1,d} with

$${F}_{0 \to t}^{l , m} , {F}_{1 \to t}^{l , m} ,$$

and the generated cost volume. The first neural network 500 may generate a feature map (F_{V}) as a result of convolution.

The electronic apparatus may input a motion information field ([R(x,y),Φ(x,y)]^{T}) to the first neural network 500. R and Φ_{IN} may represent the ratio of the magnitude (distance) of per-pixel motion vectors and the “differences between the angle of a backward motion vectors and the angle of a forward motion vectors.” The motion information field may correspond to the motion information field described with reference to FIG. 3 and/or Equation 1. The first neural network 500 may include a distance embedding module (DEM) and an angle embedding module (AEM). The first neural network 500 may generate a feature map (F_{R}) by inputting R to the DEM. The first neural network 500 may generate (F_{Φ}) by inputting Φ_{IN} to the AEM.

The first neural network 500 may input F_{V}, F_{R}, and F_{Φ} to a residual block (ResBlock) and perform pixelwise multiplication on output results. Pixelwise multiplication may be referred to as elementwise multiplication. The first neural network 500 may generate bidirectional residual motion vectors

$$( {\tilde{v}}_{t \to 0}^{l , res} and {\tilde{v}}_{t \to 1}^{l , res} )$$

by convolving the sum of the pixelwise multiplication results and F_{V}. The first neural network 500 may generate bidirectional motion vectors

$$( {\tilde{v}}_{t \to 0}^{l} and {\tilde{v}}_{t \to 1}^{l} )$$

by adding the bidirectional residual motion vectors to a bidirectional motion vector at decoding level l+1.

$${\tilde{v}}_{t \to 0}^{l} and {\tilde{v}}_{t \to 1}^{l}$$

may correspond to the bidirectional motion vector field 432 of FIG. 4.

$${\tilde{v}}_{t \to 0}^{l} and {\tilde{v}}_{t \to 1}^{l}$$

may have a scale that is 2^{(l+2)} times smaller than the image frame of the input image sequence and may be upsampled to a scale of 2² times by the upsampling neural network of the second neural network to have a scale that is 2^{l} times smaller than the image frame of the input image sequence.

FIG. 6 is a block diagram schematically illustrating a process of training a VFI model, according to an embodiment. Referring to FIG. 6, a training apparatus may generate a pyramid image sequence including image sequences of multiple scales corresponding to multiple encoding levels of an original image sequence. A training image sequence 612 may correspond to one image sequence among pyramid image sequences. The training image sequence 612 may be an image sequence corresponding to encoding level l among the pyramid image sequences. The training image sequence 612 may include a first image frame corresponding to a first time point, a second image frame corresponding to a second time point, and an intermediate image frame corresponding to an intermediate time point. The second time point may be a time point subsequent to the first time point. The intermediate time point may be a time point between the first time point and the second time point.

The training apparatus may generate motion feature maps and context feature maps by performing pyramid encoding 602 on the pyramid image sequences. The training apparatus may generate motion feature maps 614 and context feature maps 616 corresponding to the training image sequence 612. The motion feature maps 614 may include motion feature maps corresponding to the first image frame, the second image frame, and the intermediate image frame. The context feature maps 616 may include context feature maps corresponding to the first image frame and the second image frame.

The training apparatus may train a first neural network 620 and a second neural network 630 to estimate a target image frame 632 similar to the intermediate image frame according to motion feature maps 6142 corresponding to the first image frame and the second image frame. The first neural network 620 and the second neural network 630 may correspond to the first neural network 430 and the second neural network 440 of FIG. 4, respectively. The target image frame 632 may be an image frame having the same size as an image frame of the training image sequence 612. When the training image sequence 612 is an original image sequence among the pyramid image sequences used for training, the target image frame 632 may correspond to the target image frame 130 of FIG. 1.

The training apparatus may perform first training 604 based on the motion feature maps 614 and the context feature maps 616. In the first training 604, the training apparatus may input, to the first neural network 620, motion feature maps 6144 and a motion information field 654 corresponding to the first image frame and the intermediate image frame. In this case, information about the intermediate image frame may be input instead of information about the second image frame, so the first neural network 620 may estimate a backward motion vector field 6242 from the intermediate time point to the first time point and a motion vector field from the intermediate time point to the intermediate time point. Additionally, in the first training 604, the training apparatus may input, to the first neural network 620, motion feature maps 6146 and a motion information field 656 corresponding to the intermediate image frame and the second image frame. In this case, information about the intermediate image frame may be input instead of information about the first image frame, so the first neural network 620 may estimate a motion vector field from the intermediate time point to the intermediate time point and a forward motion vector field 6244 from the intermediate time point to the second time point. Desirably, the motion vector field from the intermediate time point to the intermediate time point may be a field including zeros.

In an embodiment, a loss function may be determined based on the difference between the “motion vector field from the intermediate time point to the intermediate time point” generated as a byproduct of generating the bidirectional motion vector field 624 and a vector field including zeros, and the first neural network 620 may be trained so that the loss function is reduced.

In the first training 604, desirably, the motion vector field between the intermediate image frames may need to include zeros, so the angle of per-pixel motion vectors may not be properly defined. Accordingly, the motion information field 654 and the motion information field 656 may be determined as shown in Equation 4 and Equation 5 below. pᵣ may represent the first training 604, and l may represent the encoding level of the training image sequence 612. φ₀ and φ₁ may have random values between [0, 360°(2π)]. Accordingly, the motion information field 654 and the motion information field 656 may include random per-pixel angular difference information.

$${M}_{t \to 0 , t}^{l , {𝒫}_{𝒯}} = {[ {1}_{H \times W} {ϕ}_{1} \cdot \times {10}^{1} \times 10 ]}^{T} \qquad [ Equation 4 ]$$

$${M}_{t \to t , 1}^{l , {𝒫}_{𝒯}} = {[ {1}_{H \times W} {ϕ}_{1} \cdot \times {10}^{1} \times 10 ]}^{T} \qquad [ Equation 5 ]$$

In the first training 604, the training apparatus may input, to the second neural network 630, the bidirectional motion vector field 624 and the context feature maps 616 corresponding to the first image frame and the second image frame. Although not shown in FIG. 6, the training apparatus may input, to the second neural network 630, the first image frame and the second image frame. Accordingly, the second neural network 630 may estimate and/or generate the target image frame 634 corresponding to the size of an image frame of the training image sequence 612. The target image frame 634 may be referred to as an output image frame. Additionally, the second neural network 630 may estimate and/or generate an upsampled bidirectional motion vector field and an occlusion mask and may input the upsampled bidirectional motion vector field and the occlusion mask to the first neural network 620 at decoding level (l−1).

In the first training 604, based on the difference between the intermediate image frame of the training image sequence 612 and the target image frame 634, the training apparatus may train the first neural network 620 and the second neural network 630. Based on the difference between the intermediate image frame of the training image sequence 612 and the target image frame 634, the training apparatus may determine a Charbonnier loss function. Based on one or more loss functions, the training apparatus may train the first neural network 620 and the second neural network 630 to reduce values of the loss functions. In an embodiment, the training apparatus may determine a census loss based on the intermediate image frame of the training image sequence and the target image frame 634 and train the first neural network 620 and the second neural network 630 based on the Charbonnier loss function and the census loss.

The training apparatus may perform second training 604 based on the motion feature maps 614, the context feature maps 616, and a motion information field 652. Based on the backward motion vector field 6242 and the forward motion vector field 6244, the training apparatus may calculate the motion information field 652 through Equation 1 above. The training apparatus may generate the motion information field 652 including per-pixel angle information based on per-pixel motion vector angle information of the backward motion vector field 6242 and the forward motion vector field 6244. The training apparatus may generate the bidirectional motion vector field 622 by inputting, to the first neural network 620, the motion information field 654 and the motion feature maps 6142 corresponding to the first image frame and the second image frame.

In second training 606, the bidirectional motion vector field 622 may be estimated based on the bidirectional motion vector field 624. Accordingly, in an embodiment, the training apparatus may determine a loss function based on the difference between the bidirectional motion vector field 622 and the bidirectional motion vector field 624. For example, the training apparatus may determine a loss function based on the difference between a backward motion vector field of the bidirectional motion vector field 622 and the backward motion vector field 6242 and the difference between a forward motion vector field of the bidirectional motion vector field 622 and the forward motion vector field 6244. The training apparatus may train the first neural network 620 to reduce a loss function.

In the second training 606, the training apparatus may input, to the second neural network 630, the bidirectional motion vector field 622 and the context feature maps 616 corresponding to the first image frame and the second image frame. Although not shown in FIG. 6, the training apparatus may input, to the second neural network 630, the first image frame and the second image frame. Accordingly, the second neural network 630 may estimate and/or generate the target image frame 632 corresponding to the size of an image frame of the training image sequence 612. The target image frame 632 may be referred to as an output image frame. Additionally, the second neural network 630 may estimate and/or generate an upsampled bidirectional motion vector field and an occlusion mask and may input the upsampled bidirectional motion vector field and the occlusion mask to the first neural network 620 at decoding level (l−1).

In the second training 606, based on the difference between the intermediate image frame of the training image sequence 612 and the target image frame 632, the training apparatus may train the first neural network 620 and the second neural network 630. Based on the difference between the intermediate image frame of the training image sequence 612 and the target image frame 634, the training apparatus may determine a Charbonnier loss function. Based on one or more loss functions, the training apparatus may train the first neural network 620 and the second neural network 630 to reduce values of the loss functions. In an embodiment, the training apparatus may determine a census loss based on the intermediate image frame of the training image sequence 612 and the target image frame 632 and train the first neural network 620 and the second neural network 630 based on the Charbonnier loss function and the census loss.

Training of the first neural network 620 and the second neural network 630 through decoding level l is described with reference to FIG. 6. However, it may be possible to train the first neural network 620 and the second neural network 630 at all decoding levels (k=0, 1, . . . , L−1) using another image sequence of the pyramid image sequence other than the training image sequence 612.

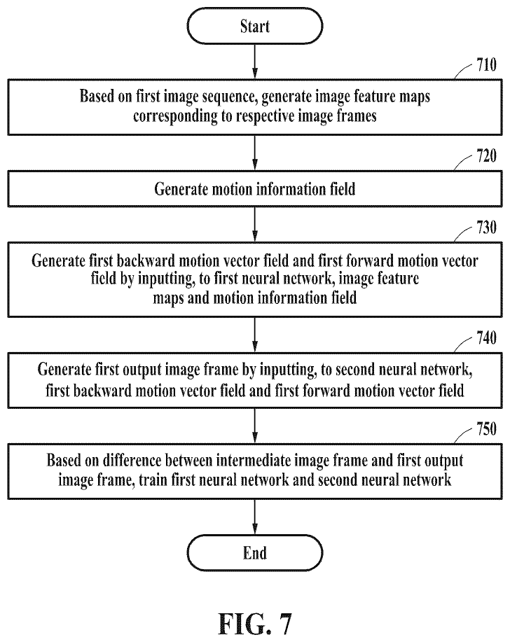

FIG. 7 is a flowchart illustrating an example of a method by which a training apparatus trains a VFI model, according to an embodiment. Referring to FIG. 7, in operation 710, based on a first image sequence, a training apparatus may generate image feature maps corresponding to respective image frames. The first image sequence may include a first image frame corresponding to a first time point, a second image frame corresponding to a second time point subsequent to the first time point, and an intermediate image frame corresponding to an intermediate time point between the first time point and the second time point.

In operation 720, the training apparatus may generate a motion information field. The motion information field may include per-pixel angular difference information between per-pixel motion vectors between the first image frame and the intermediate image frame and per-pixel motion vectors between the second image frame and the intermediate image frame.

The training apparatus may generate a second backward motion vector field by inputting, to the first neural network, image feature maps corresponding to the first image frame and the intermediate image frame. The training apparatus may generate the second backward motion vector field by inputting, to the first neural network, the image feature maps corresponding to the first image frame and the intermediate image frame and a motion information field including random per-pixel angular difference information. The training apparatus may generate a second forward motion vector field by inputting, to the first neural network, image feature maps corresponding to the second image frame and the intermediate image frame. The training apparatus may generate the second forward motion vector field by inputting, to the first neural network, the image feature maps corresponding to the second image frame and the intermediate image frame and a motion information field including random per-pixel angular difference information. Based on per-pixel motion vector angle information of the second backward motion vector field and the second forward motion vector field, the training apparatus may generate the motion information field including per-pixel angular difference information.

The training apparatus may generate a second output image frame by inputting, to a second neural network, the second backward motion vector field and the second forward motion vector field. Based on the difference between the intermediate image frame and the second output image frame, the training apparatus may train the first neural network and the second neural network.

In operation 730, the training apparatus may generate a first backward motion vector field and a first forward motion vector field by inputting, to the first neural network, the image feature maps and the motion information field. The first neural network may be a neural network trained to estimate a bidirectional motion vector field. Based on the difference between the first backward motion vector field and the second backward motion vector field and the difference between the first forward motion vector field and the second forward motion vector field, the training apparatus may train the first neural network.

In operation 740, the training apparatus may generate the first output image frame by inputting, to the second neural network, the first backward motion vector field and the first forward motion vector field. The second neural network may be a neural network trained to estimate an image frame at the intermediate time point.

In operation 750, based on the difference between the intermediate image frame and the first output image frame, the training apparatus may train the first neural network and the second neural network.

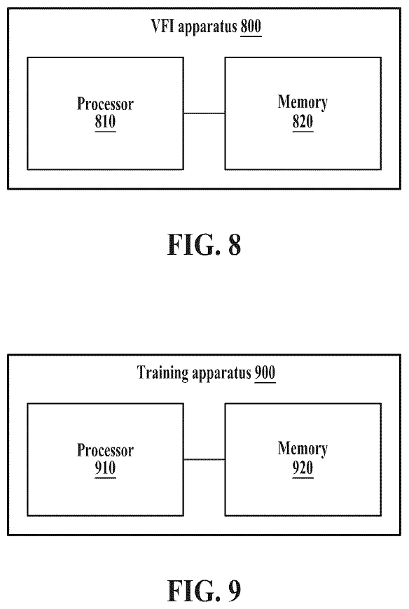

FIG. 8 is a block diagram illustrating a configuration of a VFI apparatus according to an embodiment. Referring to FIG. 8, a VFI apparatus 800 may include a processor 810 and memory 820. The memory 820 may be connected to the processor 810 and may store instructions executable by the processor 810, data to be computed by the processor 810, or data processed by the processor 810. The memory 820 may include a non-transitory computer-readable storage medium, for example, high-speed random-access memory (RAM) and/or a non-volatile computer-readable storage medium (for example, at least one disk storage device, a flash memory device, or other non-volatile solid state memory devices).

The processor 810 may execute instructions to perform the operations described with reference to FIGS. 1 to 7, 9 and 10. For example, the processor 810 may receive an input image sequence including a first input image frame at a first input time point and a second input image frame at a second input time point, determine a target motion information field including per-pixel angular difference information between per-pixel motion vectors between the first input image frame and a target image frame corresponding to a target time point between the first input time point and the second input time point and per-pixel motion vectors between the second input image frame and the target image frame, and generate a target image frame corresponding to the target time point by inputting the input image sequence and the target motion information field to a trained VFI model. In addition, the descriptions provided with reference to FIGS. 1 to 7, 9, and 10 may apply to the VFI apparatus 800.

FIG. 9 is a block diagram illustrating a configuration of a training apparatus according to an embodiment. Referring to FIG. 9, a training apparatus 900 may include a processor 910 and memory 920. The memory 920 may be connected to the processor 910 and store instructions executable by the processor 910, data to be computed by the processor 910, or data processed by the processor 910. The memory 920 may include a non-transitory computer-readable storage medium, for example, high-speed RAM and/or a non-volatile computer-readable storage medium (for example, at least one disk storage device, a flash memory device, or other non-volatile solid state memory devices).

The processor 910 may execute the instructions to perform the operations described with reference to FIGS. 1 to 8 and 10. For example, the processor 910 may generate, based on a first image sequence including a first image frame corresponding to a first time point, a second image frame corresponding to a second time point subsequent to the first time point, and an intermediate image frame corresponding to an intermediate time point between the first time point and the second time point, image feature maps corresponding to respective image frames, generate a motion information field including per-pixel angular difference information between per-pixel motion vectors between the first image frame and the intermediate image frame and per-pixel motion vectors between the second image frame and the intermediate image frame, generate a first backward motion vector field and a first forward motion vector field by inputting, to a first neural network for estimating a bidirectional motion vector field, a motion information field and image feature maps corresponding to the first image frame and the second image frame, generate a first output image frame by inputting, to a second neural network for estimating an image frame at the intermediate time point, the first backward motion vector field and the first forward motion vector field, and based on the difference between the intermediate image frame and the first output image frame, train the first neural network and the second neural network. In addition, the description provided with reference to FIGS. 1 to 8 and 10 may apply to the training apparatus 900.

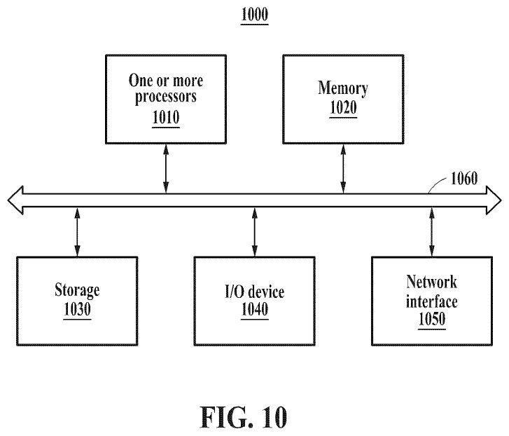

FIG. 10 is a block diagram illustrating an example of a configuration of an electronic apparatus for training a VFI model, according to an embodiment. Referring to FIG. 10, an electronic apparatus 1000 may include one or more processors 1010, memory 1020, a storage 1030, an input/output (I/O) device 1040, and a network interface 1050. These components may communicate with one another via a communication bus 1060. For example, the electronic apparatus 1000 may be implemented as at least a part of a mobile device such as a mobile phone, a smartphone, a personal digital assistant (PDA), a netbook, a tablet computer or a laptop computer, a wearable device such as a smart watch, a smart band, or smart glasses, a computing device such as a desktop or a server, a home appliance such as a television, a smart television or a refrigerator, a security device such as a door lock, or a vehicle such as an autonomous vehicle or a smart vehicle. The electronic apparatus 1000 may structurally and/or functionally include the VFI apparatus 800 of FIG. 8 and/or the training apparatus 900 of FIG. 9.

The one or more processors 1010 may execute instructions stored in the memory 1020 or the storage 1030. When executed by the one or more processors 1010, the instructions may cause the electronic apparatus 1000 to perform the operations described with reference to FIGS. 1 to 9. The memory 1020 may include a computer-readable storage medium or a computer-readable storage device. The memory 1020 may store instructions to be executed by the one or more processors 1010 and may store related information while software and/or an application is being executed by the electronic apparatus 1000.

The storage 1030 may include a computer-readable storage medium or a computer-readable storage device. The storage 1030 may store a greater amount of information than the memory 1020 for a longer period of time. For example, the storage 1030 may include a magnetic hard disk, an optical disc, flash memory, a floppy disk, or any other non-volatile memory known in the art.

The I/O device 1040 may receive an input from a user in traditional input manners through a keyboard and a mouse and in new input manners such as a touch input, a voice input, and an image input. For example, the I/O device 1040 may include a keyboard, a mouse, a touch screen, a microphone, or any other device that detects the input from the user and transmits the detected input to the electronic apparatus 1000. The I/O device 1040 may provide an output of the electronic apparatus 1000 to the user through a visual, auditory, or haptic channel. The I/O device 1040 may include, for example, a display, a touch screen, a speaker, a vibration generator, or any other device that provides the output to the user. The network interface 1050 may communicate with an external device through a wired or wireless network.

The embodiments described herein may be implemented using a hardware component, a software component and/or a combination thereof. For example, the apparatus, the method, and the components described in the embodiments may be implemented using a general-purpose or special-purpose computer, such as a processor, a controller and an arithmetic logic unit (ALU), a digital signal processor (DSP), a microcomputer, a field-programmable gate array (FPGA), a programmable logic unit (PLU), a microprocessor, or any other devices capable of responding to and executing instructions. A processing device may run an operating system (OS) and software applications that run on the OS. The processing device may also access, store, manipulate, process, and generate data in response to execution of the software. For purpose of simplicity, the description of the processing device is used as singular, however, one skilled in the art will appreciate that a processing device may include multiple processing elements and multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in computer-readable storage media.

The method according to the embodiments described above may be recorded in computer-readable storage media including program instructions to implement various operations of the embodiments described above. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, RAM, flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

According to an aspect of the disclosure, a method of training a video frame interpolation (VFI) model, the method comprising:
based on a first image sequence comprising a first image frame corresponding to a first time point, a second image frame corresponding to a second time point subsequent to the first time point, and an intermediate image frame corresponding to an intermediate time point between the first time point and the second time point, generating image feature maps corresponding to respective image frames;
generating a motion information field comprising per-pixel angular difference information between per-pixel motion vectors between the first image frame and the intermediate image frame and per-pixel motion vectors between the second image frame and the intermediate image frame;
generating a first backward motion vector field and a first forward motion vector field by inputting, to a first neural network for estimating a bidirectional motion vector field, the motion information field and image feature maps corresponding to the first image frame and the second image frame;
generating a first output image frame by inputting, to a second neural network for estimating an image frame of the intermediate time point, the first backward motion vector field and the first forward motion vector field; and
based on a difference between the intermediate image frame and the first output image frame, training the first neural network and the second neural network.

According to an aspect of the disclosure, the generating of the motion information field comprises: generating a second backward motion vector field by inputting, to the first neural network, image feature maps corresponding to the first image frame and the intermediate image frame; generating a second forward motion vector field by inputting, to the first neural network, image feature maps corresponding to the second image frame and the intermediate image frame; and based on per-pixel motion vector angle information of the second backward motion vector field and the second forward motion vector field, generating the motion information field comprising per-pixel angular difference information.

According to an aspect of the disclosure, the method of training a video frame interpolation (VFI) model, further comprising: based on a difference between the first backward motion vector field and the second backward motion vector field and a difference between the first forward motion vector field and the second forward motion vector field, training the first neural network.

According to an aspect of the disclosure, the generating of the second backward motion vector field comprises generating the second backward motion vector field by inputting, to the first neural network, a motion information field comprising random per-pixel angular difference information and image feature maps corresponding to the first image frame and the intermediate image frame, and the generating of the second forward motion vector field comprises generating the second forward motion vector field by inputting, to the first neural network, a motion information field comprising random per-pixel angular difference information and image feature maps corresponding to the second image frame and the intermediate image frame.

According to an aspect of the disclosure, the method of training a video frame interpolation (VFI) model further comprising: generating a second output image frame by inputting, to the second neural network, the second backward motion vector field and the second forward motion vector field; and based on a difference between the intermediate image frame and the second output image frame, training the first neural network and the second neural network.

According to an aspect of the disclosure, the motion information field further comprises per-pixel normalized ratios between magnitudes of the per-pixel motion vectors between the first image frame and the intermediate image frame and magnitudes of the per-pixel motion vectors between the second image frame and the intermediate image frame.

According to an aspect of the disclosure, a training apparatus comprising: one or more processors; and memory comprising instructions executable by the one or more processors, wherein the instructions, when executed by the one or more processors, cause the training apparatus to: based on a first image sequence comprising a first image frame corresponding to a first time point, a second image frame corresponding to a second time point subsequent to the first time point, and an intermediate image frame corresponding to an intermediate time point between the first time point and the second time point, generate image feature maps corresponding to respective image frames; generate a motion information field comprising per-pixel angular difference information between per-pixel motion vectors between the first image frame and the intermediate image frame and per-pixel motion vectors between the second image frame and the intermediate image frame; generate a first backward motion vector field and a first forward motion vector field by inputting, to a first neural network for estimating a bidirectional motion vector field, the motion information field and image feature maps corresponding to the first image frame and the second image frame; generate a first output image frame by inputting, to a second neural network for estimating an image frame at the intermediate time point, the first backward motion vector field and the first forward motion vector field; and based on a difference between the intermediate image frame and the first output image frame, train the first neural network and the second neural network.

According to an aspect of the disclosure, the instructions, when executed by the one or more processors, cause the training apparatus to, in order to generate the motion information field: generate a second backward motion vector field by inputting, to the first neural network, image feature maps corresponding to the first image frame and the intermediate image frame; generate a second forward motion vector field by inputting, to the first neural network, image feature maps corresponding to the second image frame and the intermediate image frame; and based on per-pixel motion vector angle information of the second backward motion vector field and the second forward motion vector field, generate the motion information field comprising per-pixel angular difference information.

According to an aspect of the disclosure, the instructions, when executed by the one or more processors, cause the training apparatus to, based on a difference between the first backward motion vector field and the second backward motion vector field and a difference between the first forward motion vector field and the second forward motion vector field, train the first neural network.

According to an aspect of the disclosure, the instructions, when executed by the one or more processors, cause the training apparatus to: generate the second backward motion vector field by inputting, to the first neural network, a motion information field comprising random per-pixel angular difference information and image feature maps corresponding to the first image frame and the intermediate image frame; and generate the second forward motion vector field by inputting, to the first neural network, a motion information field comprising random per-pixel angular difference information and image feature maps corresponding to the second image frame and the intermediate image frame.

According to an aspect of the disclosure, the instructions, when executed by the one or more processors, cause the training apparatus to: generate a second output image frame by inputting, to the second neural network, the second backward motion vector field and the second forward motion vector field; and based on a difference between the intermediate image frame and the second output image frame, train the first neural network and the second neural network.

According to an aspect of the disclosure, the motion information field further comprises per-pixel normalized ratios between magnitudes of the per-pixel motion vectors between the first image frame and the intermediate image frame and magnitudes of the per-pixel motion vectors between the second image frame and the intermediate image frame.

According to an aspect of the disclosure, a video frame interpolation (VFI) method comprising: initializing a pre-trained VFI model; receiving an input image sequence comprising a first input image frame at a first input time point and a second input image frame at a second input time point; determining a target motion information field comprising per-pixel angular difference information between per-pixel motion vectors between the first input image frame and a target image frame corresponding to a target time point between the first input time point and the second input time point and per-pixel motion vectors between the second input image frame and the target image frame; and generating the target image frame corresponding to the target time point by inputting, to the trained VFI model, the input image sequence and the target motion information field.

According to an aspect of the disclosure, the generating of the target image frame corresponding to the target time point comprises: generating image feature maps corresponding to the first input image frame and the second input image frame; generating a backward motion vector field and a forward motion vector field by inputting, to a first neural network for estimating a bidirectional motion vector field, the image feature maps and the target motion information field; and generating the target image frame by inputting, to a second neural network for estimating an image frame at the target time point, the backward motion vector field and the forward motion vector field.

According to an aspect of the disclosure, the determining of the target motion information field comprises determining the target motion information field to comprise a per-pixel angular difference of 180°.

According to an aspect of the disclosure, the determining of the target motion information field comprises determining the target motion information field to comprise per-pixel angular difference information and per-pixel motion vector magnitude difference information between per-pixel motion vectors between the first input image frame and the target image frame and per-pixel motion vectors between the second input image frame and the target image frame.

According to an aspect of the disclosure, a video frame interpolation (VFI) inference apparatus comprising: one or more processors; and memory comprising instructions executable by the one or more processors, wherein the instructions, when executed by the one or more processors, cause the video frame interpolation (VFI) inference apparatus to: initialize a pre-trained VFI model; receive an input image sequence comprising a first input image frame at a first input time point and a second input image frame at a second input time point; determine a target motion information field comprising per-pixel angular difference information between per-pixel motion vectors between the first input image frame and a target image frame corresponding to a target time point between the first input time point and the second input time point and per-pixel motion vectors between the second input image frame and the target image frame; and generate the target image frame corresponding to the target time point by inputting, to the trained VFI model, the input image sequence and the target motion information field.

According to an aspect of the disclosure, the instructions, when executed by the one or more processors, cause the video frame interpolation (VFI) inference apparatus to, in order to generate the target image frame corresponding to the target time point: generate image feature maps corresponding to the first input image frame and the second input image frame; generate a backward motion vector field and a forward motion vector field by inputting, to a first neural network for estimating a bidirectional motion vector field, the image feature maps and the target motion information field; and generate the target image frame by inputting, to a second neural network for estimating an image frame at the target time point, the backward motion vector field and the forward motion vector field.

According to an aspect of the disclosure, the instructions, when executed by the one or more processors, cause the video frame interpolation (VFI) inference apparatus to, in order to determine the target motion information field: determine the target motion information field to comprise a per-pixel angular difference of 180°.

According to an aspect of the disclosure, instructions, when executed by the one or more processors, cause the video frame interpolation (VFI) inference apparatus to, in order to determine the target motion information field: determine the target motion information field to comprise per-pixel angular difference information and per-pixel motion vector magnitude difference information between per-pixel motion vectors between the first input image frame and the target image frame and per-pixel motion vectors between the second input image frame and the target image frame.

1. A method of training a video frame interpolation (VFI) model, the method comprising:
based on a first image sequence comprising a first image frame corresponding to a first time point, a second image frame corresponding to a second time point subsequent to the first time point, and an intermediate image frame corresponding to an intermediate time point between the first time point and the second time point, generating image feature maps corresponding to respective image frames;
generating a motion information field comprising per-pixel angular difference information between per-pixel motion vectors between the first image frame and the intermediate image frame and per-pixel motion vectors between the second image frame and the intermediate image frame;
generating a first backward motion vector field and a first forward motion vector field by inputting, to a first neural network for estimating a bidirectional motion vector field, the motion information field and image feature maps corresponding to the first image frame and the second image frame;
generating a first output image frame by inputting, to a second neural network for estimating an image frame of the intermediate time point, the first backward motion vector field and the first forward motion vector field; and
based on a difference between the intermediate image frame and the first output image frame, training the first neural network and the second neural network.

2. The method of claim 1, wherein the generating of the motion information field comprises:
generating a second backward motion vector field by inputting, to the first neural network, image feature maps corresponding to the first image frame and the intermediate image frame;
generating a second forward motion vector field by inputting, to the first neural network, image feature maps corresponding to the second image frame and the intermediate image frame; and
based on per-pixel motion vector angle information of the second backward motion vector field and the second forward motion vector field, generating the motion information field comprising per-pixel angular difference information.

3. The method of claim 2, further comprising:
based on a difference between the first backward motion vector field and the second backward motion vector field and a difference between the first forward motion vector field and the second forward motion vector field, training the first neural network.

4. The method of claim 2, wherein
the generating of the second backward motion vector field comprises generating the second backward motion vector field by inputting, to the first neural network, a motion information field comprising random per-pixel angular difference information and image feature maps corresponding to the first image frame and the intermediate image frame, and
the generating of the second forward motion vector field comprises generating the second forward motion vector field by inputting, to the first neural network, a motion information field comprising random per-pixel angular difference information and image feature maps corresponding to the second image frame and the intermediate image frame.

5. The method of claim 2, further comprising
generating a second output image frame by inputting, to the second neural network, the second backward motion vector field and the second forward motion vector field; and
based on a difference between the intermediate image frame and the second output image frame, training the first neural network and the second neural network.

6. The method of claim 1, wherein the motion information field further comprises per-pixel normalized ratios between magnitudes of the per-pixel motion vectors between the first image frame and the intermediate image frame and magnitudes of the per-pixel motion vectors between the second image frame and the intermediate image frame.

7. A training apparatus comprising:
one or more processors; and
memory comprising instructions executable by the one or more processors,
wherein the instructions, when executed by the one or more processors, cause the training apparatus to:
based on a first image sequence comprising a first image frame corresponding to a first time point, a second image frame corresponding to a second time point subsequent to the first time point, and an intermediate image frame corresponding to an intermediate time point between the first time point and the second time point, generate image feature maps corresponding to respective image frames;
generate a motion information field comprising per-pixel angular difference information between per-pixel motion vectors between the first image frame and the intermediate image frame and per-pixel motion vectors between the second image frame and the intermediate image frame;
generate a first backward motion vector field and a first forward motion vector field by inputting, to a first neural network for estimating a bidirectional motion vector field, the motion information field and image feature maps corresponding to the first image frame and the second image frame;
generate a first output image frame by inputting, to a second neural network for estimating an image frame at the intermediate time point, the first backward motion vector field and the first forward motion vector field; and
based on a difference between the intermediate image frame and the first output image frame, train the first neural network and the second neural network.

8. The training apparatus of claim 7, wherein the instructions, when executed by the one or more processors, cause the training apparatus to, in order to generate the motion information field:
generate a second backward motion vector field by inputting, to the first neural network, image feature maps corresponding to the first image frame and the intermediate image frame;
generate a second forward motion vector field by inputting, to the first neural network, image feature maps corresponding to the second image frame and the intermediate image frame; and
based on per-pixel motion vector angle information of the second backward motion vector field and the second forward motion vector field, generate the motion information field comprising per-pixel angular difference information.

9. The training apparatus of claim 8, wherein the instructions, when executed by the one or more processors, cause the training apparatus to, based on a difference between the first backward motion vector field and the second backward motion vector field and a difference between the first forward motion vector field and the second forward motion vector field, train the first neural network.

10. The training apparatus of claim 8, wherein the instructions, when executed by the one or more processors, cause the training apparatus to:
generate the second backward motion vector field by inputting, to the first neural network, a motion information field comprising random per-pixel angular difference information and image feature maps corresponding to the first image frame and the intermediate image frame; and
generate the second forward motion vector field by inputting, to the first neural network, a motion information field comprising random per-pixel angular difference information and image feature maps corresponding to the second image frame and the intermediate image frame.

11. The training apparatus of claim 8, wherein the instructions, when executed by the one or more processors, cause the training apparatus to:
generate a second output image frame by inputting, to the second neural network, the second backward motion vector field and the second forward motion vector field; and
based on a difference between the intermediate image frame and the second output image frame, train the first neural network and the second neural network.

12. The training apparatus of claim 7, wherein the motion information field further comprises per-pixel normalized ratios between magnitudes of the per-pixel motion vectors between the first image frame and the intermediate image frame and magnitudes of the per-pixel motion vectors between the second image frame and the intermediate image frame.

13. A video frame interpolation (VFI) method comprising:
initializing a pre-trained VFI model;
receiving an input image sequence comprising a first input image frame at a first input time point and a second input image frame at a second input time point;
determining a target motion information field comprising per-pixel angular difference information between per-pixel motion vectors between the first input image frame and a target image frame corresponding to a target time point between the first input time point and the second input time point and per-pixel motion vectors between the second input image frame and the target image frame; and
generating the target image frame corresponding to the target time point by inputting, to the trained VFI model, the input image sequence and the target motion information field.

14. The VFI method of claim 13, wherein the generating of the target image frame corresponding to the target time point comprises:
generating image feature maps corresponding to the first input image frame and the second input image frame;
generating a backward motion vector field and a forward motion vector field by inputting, to a first neural network for estimating a bidirectional motion vector field, the image feature maps and the target motion information field; and
generating the target image frame by inputting, to a second neural network for estimating an image frame at the target time point, the backward motion vector field and the forward motion vector field.

15. The VFI method of claim 13, wherein the determining of the target motion information field comprises determining the target motion information field to comprise a per-pixel angular difference of 180°.

16. The VFI method of claim 13, wherein the determining of the target motion information field comprises determining the target motion information field to comprise per-pixel angular difference information and per-pixel motion vector magnitude difference information between per-pixel motion vectors between the first input image frame and the target image frame and per-pixel motion vectors between the second input image frame and the target image frame.

17. A video frame interpolation (VFI) inference apparatus comprising:
one or more processors; and
memory comprising instructions executable by the one or more processors, wherein the instructions, when executed by the one or more processors, cause the video frame interpolation (VFI) inference apparatus to:
initialize a pre-trained VFI model;
receive an input image sequence comprising a first input image frame at a first input time point and a second input image frame at a second input time point;
determine a target motion information field comprising per-pixel angular difference information between per-pixel motion vectors between the first input image frame and a target image frame corresponding to a target time point between the first input time point and the second input time point and per-pixel motion vectors between the second input image frame and the target image frame; and
generate the target image frame corresponding to the target time point by inputting, to the trained VFI model, the input image sequence and the target motion information field.

18. The VFI inference apparatus of claim 17, wherein
the instructions, when executed by the one or more processors, cause the video frame interpolation (VFI) inference apparatus to, in order to generate the target image frame corresponding to the target time point:
generate image feature maps corresponding to the first input image frame and the second input image frame;
generate a backward motion vector field and a forward motion vector field by inputting, to a first neural network for estimating a bidirectional motion vector field, the image feature maps and the target motion information field; and
generate the target image frame by inputting, to a second neural network for estimating an image frame at the target time point, the backward motion vector field and the forward motion vector field.

19. The VFI inference apparatus of claim 17, wherein
the instructions, when executed by the one or more processors, cause the video frame interpolation (VFI) inference apparatus to, in order to determine the target motion information field:
determine the target motion information field to comprise a per-pixel angular difference of 180°.

20. The VFI inference apparatus of claim 17, wherein
the instructions, when executed by the one or more processors, cause the video frame interpolation (VFI) inference apparatus to, in order to determine the target motion information field:
determine the target motion information field to comprise per-pixel angular difference information and per-pixel motion vector magnitude difference information between per-pixel motion vectors between the first input image frame and the target image frame and per-pixel motion vectors between the second input image frame and the target image frame.
